(19) United States
(12) Patent Application Publication
(10) Pub. No.: US 2025/0027617 A1
(43) Pub. Date: Jan. 23, 2025

(54) PRESSURE VESSELS, MORE PARTICULARLY FOR HYDROGEN, PRESSURE STORAGE SYSTEMS, AND PRODUCTION OF SAID PRESSURE VESSELS

(71) Applicant: MAHNKEN & PARTNER GMBH, Ahausen (DE)

(72) Inventor: Claus-Lüder MAHNKEN, Ahausen (DE)

(21) Appl. No.: 18/707,325

(22) PCT Filed: Nov. 17, 2022
(86) PCT No.: PCT/EP2022/082294

§ 371 Date: May 3, 2024

(30) Foreign Application Priority Data
Nov. 18, 2021 (DE) 10 2021 130 123.8

(51) Int. Cl. F17C 13/12; F17C 1/06

(52) U.S. Cl. CPC F17C 13/12; F17C 1/06; F17C 2203/0619; F17C 2203/0639; F17C 2205/0332

(57) ABSTRACT

The following invention relates, in a first aspect, to a pressure vessel for receiving and storing gases, more particularly hydrogen. The pressure vessel comprises a main body of metal together with an outer shell, the outer shell having sensor elements and reinforcing elements, with optional transmitters and/or receivers of information and electric fields present optionally in the outer shell. The present invention also relates to corresponding pressure storage systems having pressure vessels of this type, to devices having fuel cells and pressure vessels according to the invention, and to methods for producing said pressure vessels.

The following invention relates, in a first aspect, to a pressure vessel for receiving and storing gases, more particularly hydrogen. The pressure vessel comprises a main body of metal together with an outer shell, the outer shell having sensor elements and reinforcing elements, with optional transmitters and/or receivers of information and electric fields present optionally in the outer shell. The present invention also relates to corresponding pressure storage systems having pressure vessels of this type, to devices having fuel cells and pressure vessels according to the invention, and to methods for producing said pressure vessels.

### PRIOR ART

The storage of gases, in particular pressure vessels for storing hydrogen, is well known. Pressure storage systems are generally employed for gas and in particular hydrogen storage in wide-ranging applications. These areas of application include vehicles, aircraft, but also industry and medicine. The gases are usually under high compression in order to store the gas under high pressure in the pressure storage unit to save as much space as possible. In contrast to liquid fossil fuels, which are stored under ambient conditions, i.e. ambient temperature and pressure, gases and especially hydrogen are compressed at very high pressure in order to store sufficient quantities of gas in the pressure vessel. These pressure storage systems must therefore be designed accordingly in order to meet the necessary safety regulations. This applies to these pressure storage systems above all for a wide range of mechanical, thermal and chemical loads in the corresponding operational situations. This aspect plays a particularly important role in the storage of hydrogen in the context of electromobility. Fuel cell drives, as used in automobiles, commercial vehicles, trains, ships and aircraft, such as airplanes, require a safe, lightweight, stable and reliable tank container in the form of a pressure vessel.

However, corresponding transport containers and stationary facilities with a high safety standard also require corresponding pressure vessels that meet these high safety standards. Permanent monitoring of the pressure vessels and pressure storage systems plays a particularly important role here in order to detect corresponding changes in the status variables of the pressure storage system and the pressure vessels. These changes in state can occur due to various circumstances, such as mechanical, thermal and chemical stresses, which in particular cause a change in the vessel geometry. Such events, conditions or influences require rapid intervention in order to avoid critical situations, in particular unwanted gas leakage, bursting and exploding of the pressure vessels.

On the other hand, these pressure storage systems need to be as light as possible, yet robust with optimum space utilization and high safety standards. This leads to high standards and requirements for the corresponding pressure vessels and the materials used to manufacture them. Due to the highly compressed gas in the storage units, these systems are exposed to high loads, whereby these vessels are subject to extreme changes during filling but also during storage, e.g. due to high temperature differences, load changes, etc.

The materials must also be selected in such a way that they have an appropriate permeation barrier to the gas they contain. On the other hand, they must be able to withstand high pressure.

Currently, pressure vessels, and here in particular pressure vessels for hydrogen storage, are divided into different types for stationary and mobile use. These types differ in their design and the materials used, e.g. in order to achieve the greatest possible weight reduction while retaining the mechanical, thermal and chemical properties. The types of hydrogen pressure storage units are as follows:

Type 1 is suitable for stationary use and transportation. These are usually thick-walled steel cylinders of conventional design that can withstand pressures of up to 200 bar (20 mPa).

Type 2 is a further development of type 1, in which a partially flat shell of carbon fiber or glass fiber is applied to the metal construction. This type is also suitable for transportation and stationary operation, but especially for use in hydrogen filling stations. This type can be operated at higher pressures up to 1,000 bar (100 mPa).

Type 3, with a metallic main body with composite full wrap, usually consists of an aluminum main body and a carbon fiber shell. This type is the standard design in current fuel cell technology and is configured for pressures of 350 to 700 bar (35 to 70 mPa). One advantage of this type over the aforementioned types is its low weight, making the corresponding types of pressure vessels suitable for use in vehicles.

Type 4 is a further development of type 3, in which the metal main body is replaced by a core made of plastic, usually polyethylene or polyamide. This type can also withstand pressures of 350 to 700 bar (35 to 70 mPa), while achieving a significant weight reduction compared to type 3.

Type 5 is a variant that has no main body but consists solely of carbon fibers in a resin matrix; this type 5 is also intended for pressures of 350 to 700 bar (35 to 70 mPa).

In addition to this distinction, pressure storage units and pressure vessels are also differentiated according to the storage medium and the application. Thus, a distinction is made between LPG vessels for liquid fuel gas, CNG vessels for compressed natural gas and CHG vessels for compressed hydrogen. A distinction is also made between the corresponding application, such as industrial gas pressure vessels, diving cylinders and breathing air pressure vessels, liquid gas vessels and, for example, hydrogen pressure vessels in both industrial and mobile applications.

Weight plays a particularly important role in mobile applications. Therefore, the aforementioned type 3 and especially type 4 hydrogen pressure vessels are used in the mobile sector to ensure sufficient strength and safety while reducing weight. In general, the permeation barrier is provided by the main body based on a metal or plastic, while the shell, reinforced with carbon fiber, absorbs the pressure loads and mechanical loads, especially from the outside.

Such pressure vessels must be able to sustain high operational safety under long-term loads, whereby they are subject to constant load changes.

Gas pressure sensors are currently used to monitor the gas pressure in corresponding pressure storage systems and pressure vessels. In addition, these pressure vessels have safety systems to release the gas in a controlled manner if necessary. In types 3 and 4 tanks, fiber composite materials are equipped with sensors to monitor the load status of the pressure reservoir, with these sensors being laminated and integrated directly into the fiber composite component. DE 10 2006 035 274 B4 describes a fiber composite component, for example a pressure vessel with a sensor unit that is fully integrated in the component between the fiber composite layers. In addition, corresponding monitoring systems for these vessels are known, in which corresponding pressure sensors are used for monitoring.

Due to the different areas of application, mobile application, stationary application, industrial application, vehicle application, etc., different requirements are placed on the safety of the storage systems. In addition, possible influencing factors that change the load condition of the pressure reservoir are different. This applies in particular to mobile pressure vessels, such as those used in vehicle construction, aircraft construction, etc. In mobile embodiments, the aim is to achieve maximum fuel supply with minimum container weight and size. Accordingly, the various types are further developed in order to achieve a reduction in weight while maintaining the pressure that can be applied. However, sudden and unusual changes that could cause a hazardous situation must be taken into account. Examples in the case of mobile applications include vehicle accidents, external influences and damage in the event of contact or collision, etc. Furthermore, material weaknesses must be taken into account so that changes in condition can be quickly and easily detected and dangerous situations recognized. With hydrogen in particular, early detection of dangerous situations and appropriate countermeasures are necessary to prevent dangerous situations such as hydrogen leaks and the possible formation of oxyhydrogen gas.

Accordingly, the use of storage types that have shells or even consist entirely of plastics and fiber reinforcements based on carbon fibers or glass fibers is limited. Matrix systems have limited mechanical, thermal and chemical resistance. In fact, composite materials with high-performance fibers are highly sensitive to impact and breakage and pose a safety risk. Overloading, mechanical influences on the fibers, the composite materials or the laminate can lead to damage that may not be visually recognizable, but nevertheless represent a risk. In particular, such damage to the material cannot be detected during operation, but requires removal and a high level of technical effort to detect.

Various solutions have been proposed to detect critical situations, especially during use. Among others, DE 10 2018 115 540 A1 describes a pressure storage system with a situation-detecting casing based on a layer with piezoresistive properties made of a resistance material with a contact in order to detect, document and evaluate the load, pressure, strain or temperature acting on the pressure storage system.

CN 106696315 A relates to a pressure-resistant gas cylinder for intelligent monitoring of the three-dimensional composite material and a method for its manufacture. WO 2007/076026 A2 describes safety features for on-board hydrogen storage containers.

The object of the present invention is to provide pressure vessels, in particular safety pressure vessels for hydrogen, with an expansion capability, wherein a plurality of sensors are present for permanently monitoring the vessel.

### DESCRIPTION OF THE INVENTION

In a first aspect, a pressure vessel for receiving and storing gases and in particular hydrogen is provided, wherein this pressure vessel comprises a main body made of metal. The inside of this metal comes into contact with the gas in the pressure vessel. Furthermore, this pressure vessel comprises an outer shell surrounding the main body. The main body itself is equipped with an inlet and an outlet and may also have at least one pressure relief valve. The inlet and outlet valves can be separate components or one component.

The shell is formed at least in some areas around the outside of the metal main body and is a multi-layered shell. A first layer, which is arranged on the main body, is one which has a plurality of sensor elements for detecting state variables, this plurality of sensor elements being arranged at a distance from one another in a fixed position in an elastomer and this elastomer being a component of the first layer. In a second layer of this multi-layer shell, which is laid out on the first layer, there are reinforcing elements embedded in a matrix, in particular tensile cords. If necessary, a transmitter for sending electrical fields and, if necessary, a receiver for receiving information are arranged in the first and/or second layer, wherein the sensor elements, receiver and transmitter are preferably connected to each other by means of signal technology. In one embodiment, the transmitter and/or receiver may be present in one or more of the layers of the outer shell. In another embodiment, transmitters and/or receivers are arranged outside the pressure vessel in such a way that the sensor elements can signal their information in such a way that the transmitters receive this information. This means that in one embodiment, the transmitter and receiver can be arranged in an enclosure or the like, for example. In particular, this allows the pressure vessel to be replaced without having to replace the transmitter and/or receiver. If necessary, the power supply to the sensor elements can also be tracked via the transmitters. Alternatively, it may be sufficient to use energy that is naturally available in the environment. For the sensors known as smart dust sensors in particular, an energy supply provided by electric fields, known as electric smog, is sufficient.

The person skilled in the art is familiar with corresponding arrangements of transmitters and receivers, in particular also an arrangement of these elements outside the pressure vessel, i.e. outside the corresponding layers.

In one embodiment, the transmitter can be one that transmits at a predetermined frequency and the receiver one that records a change in frequency via the sensor in order to obtain corresponding data on the state of the main body. Alternatively, the transmitter can be one that transmits different frequencies, e.g. as scatter radiation, in order to detect frequency deviations that allow data to be recorded on the condition of the pressure vessel.

If transmitters and/or receivers are present in at least one of the layers, in one embodiment these are present in the form of conductive structures with which corresponding electric fields are formed within the outer shell. Accordingly, metal wires or metallized structures can be present as transmitters and/or receivers. In one embodiment these are present in the layer in which the reinforcing elements, such as tensile cords, are also present. In one embodiment, the conductive material, such as the metal wire or metallized structures, e.g. metallized threads, can be part of the tensile cord, such as aramid tensile cords.

The metal main body can serve in particular as an arrester of electric fields, e.g. as a neutral conductor. This means that the metal main body allows the reference potential for the field lines of the alternating electric field to be formed, via which the corresponding sensor elements are supplied with energy, for example. For example, corresponding alternating fields are formed between external electrodes and the metal main body, wherein these metal main bodies then discharge the electrical charges accordingly.

In one embodiment, the sensor elements are transceivers. A transceiver is a device that can both receive and transmit data or signals. In particular, these are nanosensors that are present in a plurality as transceivers in a first layer. The person skilled in the art is familiar with corresponding sensor elements. In one embodiment, these sensor elements are those that communicate with each other and, in particular, exchange their positions relative to each other and transmit them to the receiver. This signal transmission to the receiver can be such that the sensors permanently communicate their positions relative to each other or merely transmit changes in position via the receiver in the form of a signal transmission.

So-called smart dust elements, as described in the prior art, are particularly suitable sensor elements. These are nano-sized sensors that can receive, process and transmit data as transceivers. These elements can be supplied with energy simply by electrical capacitive transmission. Here, the smallest amounts of energy are required to generate and transmit the corresponding data. In some cases, electrical fields known as “electrosmog” are enough to supply the sensors with sufficient energy. In one embodiment, the energy supply is provided by an alternating field generator, which consumes only a few MW of electrical energy. For example, corresponding charges are transferred from the alternating electric field every 10 μs.

These low energy levels, e.g. at currents of 100 nA and a low power consumption of approximately 100 nW per sensor element, prevent sparking.

By communicating with each other and thus recognizing each other's position, these sensor elements allow possible changes in the status of the pressure vessel to be indicated very quickly. This allows geometric changes in the vessel body due to pressure, temperature or mechanical influences and information, i.e. uneven deformations, to be displayed. It is thus possible to fully monitor the pressure vessels in terms of safety.

In addition to the geometric position of the sensors, they can also detect temperature and pressure if required. Individual separate sensors are therefore not necessary.

As explained, depending on the frequencies used by the transmitter, additional information and data can be transmitted by the sensors to the receiver, such as a frequency change of predetermined frequencies. These corresponding data can, for example, record information on temperature, pressure or similar using sensors.

The corresponding data are then forwarded via the receiver and processed accordingly. If necessary, data can only be transmitted if the data pass on safety-related information, such as geometric changes that exceed specified limit values.

In the event of safety-relevant data, corresponding alarm signals are then sent to the computer unit and monitoring unit, which then trigger further actions. The signals can be transmitted via standard frequencies to an external control center or to a cloud.

For example, suitable smart dust elements are known from the companies Dust Network Inc. and Hitachi.

In one embodiment, the pressure vessel has a permanent electrical contact; if necessary, a local power source can be permanently or detachably connected to the pressure vessel. As explained, the electrical fields known as “electrosmog” can also be sufficient to supply the sensor elements with the necessary energy.

This means that there can be a wireless connection between the transmitter/receiver or electrical source and the pressure vessel, but there can also be a wired connection between the pressure vessel and the corresponding sensors and control units.

In one embodiment, the main body is made of a steel, in particular stainless steel, which is particularly diffusion-resistant to hydrogen. For example, the stainless steel main body is manufactured in such a way that a welded and drawn cylinder with hemispheric elements attached and welded on both sides, which are also made of stainless steel, is used. Connections for filling and emptying as well as an emergency outlet, usually a pressure relief valve, are attached to this stainless steel main body. This emergency outlet, for example in the form of a pressure relief valve, can be controlled with the aid of the computer unit, which receives and processes data from the sensor elements. In an emergency situation, pressure can then be relieved very quickly in order to overcome safety-relevant situations.

Main bodies made of metal, such as noble metal, are usually ductile, whereby the ductility depends on the wall thickness. Stainless steel main bodies have a high modulus of elasticity of approximately 200 kN/mm², for example.

In particular, the main body usually has an elongation or extensibility that is greater than the shell. The shell serves to increase the stability of the vessel. The main body is preferably suitable for low and high temperatures, i.e. ranging from −200 to 250° C., as is achieved with conventional stainless steels. Since the hydrogen gas filling process involves strong cooling in order to fill the tank, low-temperature suitability is necessary. The same also applies to use in aircraft operating at high altitudes.

Suitable valves can be installed on the main body or its inlet and/or outlet, which, if a critical state is detected, not only open the vessel container via the pressure relief valve, but also via these valves. This means that the pressure vessel can deform up to a certain limit range without reaching a critical state, namely within the predetermined elastic expansion range of the vessel, which results from the load changes and the pressures within the vessel. Only when a critical state is reached, e.g. when the predetermined limit values of this deformation are exceeded, is a corresponding correction made via the control unit. The advantage here is that no additional discrete and separate pressure sensors or piezo elements or expansion gauges etc. need to be installed on these pressure vessels. Hydrogen detectors are also superfluous, as the vessel does not leak at critical moments or the hydrogen gas is already drained off before total destruction.

In one embodiment, nitrogen is also present as part of an emergency emptying of hydrogen, e.g. in the form of a pressure cartridge. This allows hydrogen, for example, to be completely removed from the system.

In the case of aircraft, an altitude sensor may be present in order to detect a possible gravitational acceleration, e.g. in the event of a crash, and to initiate a targeted automatic depressurization via the control unit or directly.

According to the invention, a plurality of the sensor elements is present in the first layer, which is arranged on the main body. In one embodiment, this first layer adheres to the metal of the main body with the aid of an adhesion promoting layer.

In one embodiment, the sensor elements are distributed on a first film and then covered with a second, preferably elastomer film, in a sandwich-like manner. This combination of films with sensor elements is then vulcanized using a suitable system, e.g. via continuous elastomer-tape-film vulcanization. This results in a corresponding foil or mat in which the sensor elements are spaced apart in a fixed position and this foil can be used to encase the stainless steel main body. Suitable adhesives for the elastomer films described are, for example, those based on Chemosil from Lord and/or isocyanate or PU adhesives.

Elastomers based on EPDM or EPM materials are particularly suitable. These adhesives have excellent low-and high-temperature stability, so that they can also be used at low temperatures.

Alternatively, materials based on HNBR rubber can also be used as elastomers.

In one embodiment, the reinforcing elements are tensile strands or cords, as known from belt technology, for example. Such materials are particularly suitable as reinforcing elements in the second layer, which is arranged on the outside of the first layer. In one embodiment, these tensile cords have aramid fibers or consist of aramid fibers. Suitable aramids are in particular: aramid, aromatic polyamides such as meta- or para-aramid, e.g. poly-p-phenylene terephthalamide, manufacturers include Kevlar (DuPont) Twaron and Technora (Teijin Twaron) (p-aramid) as well as Teijinconex (m-aramid=poly-m-phenylene isophalamide).

In one embodiment, these tensile cords are wound crosswise, i.e. the reinforcing elements, such as the tensile cords, are formed in at least two layers. The winding tension and the crossing angle of the winding are matched to the size and geometry of the main body.

As an alternative to these tensile cords, strong film strips can also be used, e.g. those based on UHMWPE (Ultra High Molecular Weight Polyethylene) available from Endomax, for example.

In one embodiment, the fiber material, which forms the tensile cords with the aid of reinforcing elements, can be pre-stretched to a desired degree of elongation. Suitable methods are known to the skilled person.

In the case of aramid tensile cords in particular, excellent levels of tensile strength can be achieved that are comparable with prior art fibers such as carbon fibers. Compared to carbon fibers, however, higher elongation at break can be achieved, so that aramid tensile cords are advantageously used.

In fact, embodiments with aramid tensile cords as reinforcing elements, with these in particular being cross-wound in the second layer, and stainless steel main bodies as hydrogen pressure vessels are suitable according to the invention.

In one embodiment, these reinforcing elements, such as the tensile cords and in particular the tensile cords formed from aramid fibers, may further comprise metal wires or metallized fibers or wires which may serve as transmitters and/or receivers according to the invention. In addition, the impact resistance and mechanical loads of aramid fiber-based reinforcing elements are improved compared to carbon fiber elements, which are susceptible to compression loads and break correspondingly quickly. This is particularly advantageous for damage that is not immediately visible.

Furthermore, carbon fiber components have a worse CO2 footprint than those with aramid fibers. The production of carbon fiber components in particular is very costly, as the resin matrix has to be printed into the fiber bundles (filaments) using high-pressure and vacuum phases, with temperatures of around 400° C. being required.

The use of aramid fibers is therefore more cost-effective and easier to implement. High stability at high and low temperatures can be achieved thanks to the reinforcing elements. This outer shell with the reinforcing elements has a high tensile strength, which is greater than that of the main body and with excellent resilience. The materials according to the invention are flame retardant with low weight, good abrasion resistance, cut resistance, stowage stability, good impact strength and shock energy absorption.

In one embodiment, the tensile cords are wound onto the surface of the first layer in the form of a twisted and twined multifilament as a tensile cord; usually two to ten tensile cords are wound in parallel, e.g. crossed at an angle of between 15 and 35 degrees.

Suitable fixing matrices are used to fix the reinforcing elements in place. Such matrices are known, e.g. flame-retardant epoxy resins that serve as a matrix embedding medium are suitable. Flame retardancy may be achieved by using additives such as aluminum hydroxide. Suitable epoxy resins include those based on bisphenol A diglycidyl ether, for example. By adding e.g. epichlorohydrin and a hardener, the condensation reaction is started in order to hold temperature-stable and impact-resistant plastics with fixed tensile cords or reinforcing elements in general. These also give the entire vessel body a high level of strength. If necessary, the tensile cords, e.g. the aramid tensile cords, are protected from the effects of visible and non-visible light, such as UV radiation, by coloring the epoxy resin dark. Hardeners such as aminobenzene, diethyltetraamtetamine or hexalhydrophthalic anhydride are usually used in the conversation reaction. In an ionic addition reaction, a plastic matrix can be created that meets the high requirements of a safety component. In one embodiment, when aramid tensile cords are used, they are stiffened with isocyanate so that penetration of the fiber elements of the resin matrix is not necessary. For better adhesion to the resin matrix, the tensile cord is coated in a thermally hardened TFL layer. Suitable materials for coating and as isocyanates are known.

If necessary, a robust outer layer may also be present, e.g. one based on an HDI isocyanate. This layer is extremely abrasion and impact resistant.

In one embodiment, corresponding pressure vessels can be present which have aramid tensile cords as reinforcing means, wherein a fiber bundle of individual aramid filaments is present. These may optionally also have the metallic wires or metallized threads described. If necessary, these fiber bundles are stiffened with isocyanate and additionally coated with a resozin-formaldehyde latex material. In one embodiment, the shell essentially completely encloses the main body.

The pressure vessel according to the invention has various advantages over the prior art, such as superior expandability and formability, especially as a stainless steel aramid pressure vessel. The materials used are inexpensive and production is much simpler than with carbon fibers. Due to their design, these pressure vessels are particularly suitable for integrating the sensor elements as safety components, e.g. also in unmanned vehicle technology, especially aircraft technology. In particular, the present system comprising the above-mentioned sensor elements, transmitters and receivers constitutes a self-sufficient safety system in an embodiment that can react to critical situations before the hazardous situation arises.

The pressure vessels according to the invention can be adapted to the application; corresponding manufacturing methods are described and explained below. In a further aspect, the present invention therefore relates to a method of manufacturing a pressure vessel according to the invention, comprising the steps of
a. provision of the main body;
b. at least partial encasing of the main body with a first layer, this first layer comprising a plurality of sensor elements for detecting state variables, with this plurality of sensor elements being arranged at a distance from one another in a stationary manner in an elastomer, and wherein this first layer is applied to the outer surface of the main body, optionally with the aid of an adhesion promoting layer
c. winding of tensile cords, in particular aramid tensile cords, around this main body having a first layer, in particular winding by cross-winding of the tensile cord;
d. application of the fixation matrix and the embedding medium of the tensile cords and curing thereof; if necessary, application of an outer layer on the second layer and curing thereof.

In one aspect, the first layer for application to the main body is obtained by applying the plurality of sensor elements to a film and then applying an elastomer film with subsequent lamination, e.g. by vulcanization.

The sensor elements can be embedded in a PE film by the manufacturer, for example. During vulcanization, the film is completely absorbed by the elastomer material and integrated so that the elements can then move freely in the elastomer matrix.

According to the invention, a corresponding pressure storage system comprising a pressure vessel according to the invention is further provided.

In one embodiment, the pressure storage system comprising the pressure vessel according to the invention has a device for generating or transmitting electric fields, in particular an alternating field generator for generating electric fields. Furthermore, in one embodiment, the pressure storage system according to the invention has a control unit for processing the data received from the sensors, in particular for processing the geometric information of the sensors in relation to one another and the geometric behavior of the pressure vessel on the basis of the relative changes in the position of the sensor elements in relation to one another, If necessary, an output unit can be further provided. This output unit can then be used as a means of visualizing the pressure storage system and the changes in the state variables determined by the sensor elements in the pressure vessel according to the invention.

In a further embodiment, the pressure storage system according to the invention has a device including a control unit for controlling the release of the gas in the vessel, in particular via the pressure relief valve or via the outlet valve. According to the invention, countermeasures can thus be initiated in safety-relevant situations in the pressure storage system even before a dangerous situation occurs, in particular by releasing the gas, such as hydrogen. The pressure storage system according to the invention is in particular one for storing hydrogen. In particular, it is designed as one that can be used for mobile applications. In other words, according to the invention, pressure vessels or pressure storage systems are provided which are used in the mobile sector. According to the invention, a device, such as a vehicle, is provided which has a pressure storage system according to the invention or a pressure vessel according to the invention, possibly a device with fuel cells. In particular, the device is selected from automobiles, commercial vehicles, trains, ships and aircraft, including airplanes, drones, etc. With reference to the attached figures, the object of the invention is explained in more detail.

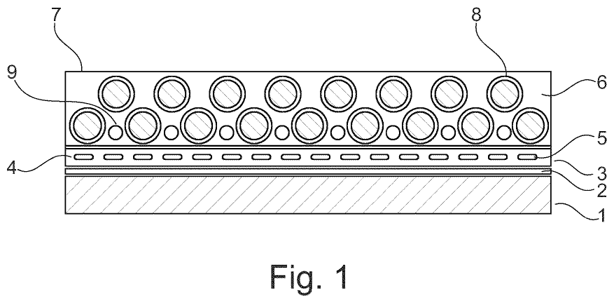

FIG. 1 is a sectional view of a container wall of a pressure vessel 20 according to the invention. Shown is the stainless steel wall 1, which at the same time can also be the neutral conductor. According to the invention, an adhesion promoter is applied to this stainless steel wall 1 to form the first adhesion promoting layer 2. A first layer 3 with the sensor elements 5 embedded in the elastomer 4 is located on this adhesion promoting layer 2.

The sensor elements 5 are distributed in the elastomer 4. On the outside of this is the second layer 6 with the reactive resin matrix 7. According to the invention, aramid tensile cords 8 stiffened with isocyanate are present in this matrix 7. Also shown are suitable metal wires or metallized threads 9 as receivers and, if necessary, transmitters.

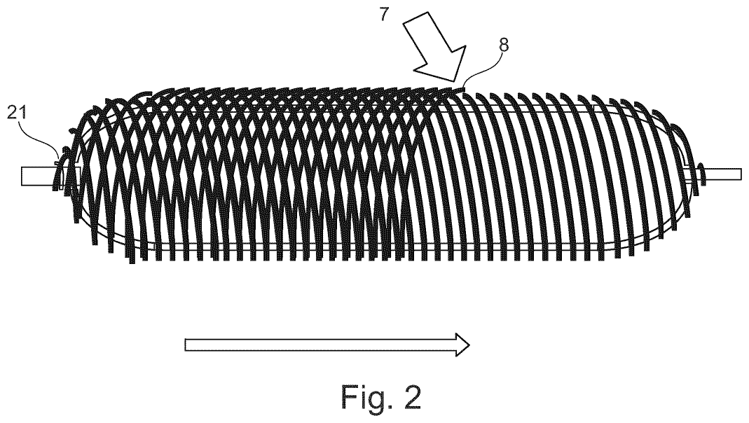

FIG. 2 shows a winding of the tensile cords, such as the aramid tensile cords 8 on the main body 21. The corresponding cross winding is shown. The reactive resin matrix 7 is then applied to this.

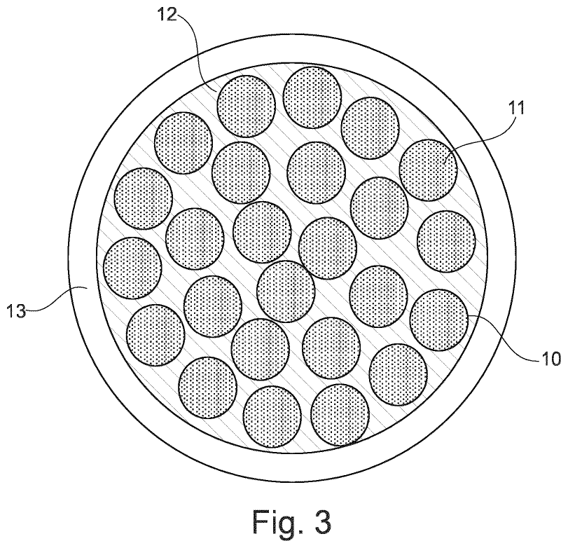

FIG. 3 shows a cross-section of a usable tensile cord 8 according to the invention, in this case an aramid tensile cord. The fiber bundles 10 of the aramid fiber with the individual filaments 11 can be seen. Also shown is the isocyanate stiffener 12 of the aramid fiber. This aramid fiber is encased by RFL cover 13.

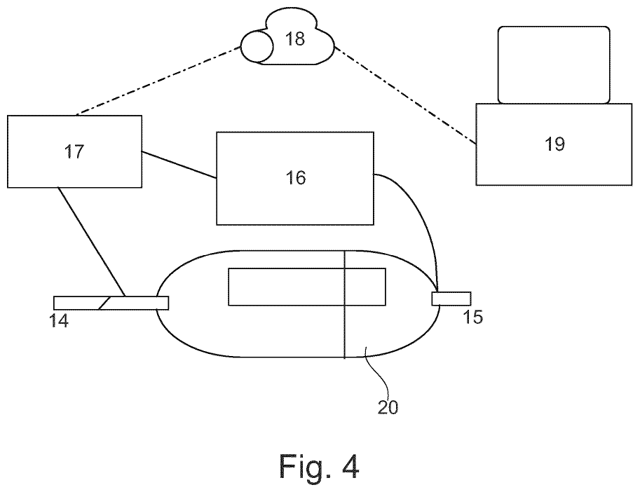

FIG. 4 shows the sensor system according to the invention. The pressure vessel 20 with the shell according to the invention and the inlet and outlet valves 14 and the pressure relief valve 15 transmits its information by means of the microsensor elements, in particular the small dust sensors, to the receiver 16, which may be a generator and transmitter. This is then connected to a corresponding evaluation unit 17, which controls the outlet valves or the pressure relief valves via corresponding interfaces.

The evaluation unit monitors and controls the valves accordingly and can be connected to a data acquisition system 19 via the cloud 18.

### List of reference signs

1—stainless steel wall
2—adhesion promoting layer
3—first layer
4—elastomer
5—sensor element
6—second layer
7—reactive resin matrix
8—tensile cords
9—metal wire, metallized thread
10—fiber bundle
11—filament
12—isocyanate stiffener
13—RFL cover
14—inlet/outlet valve
15—pressure relief valve
16—receiver
17—evaluation unit
18—cloud
19—data acquisition
20—pressure vessel
21—main body

1. A pressure vessel for receiving and storing gases, comprising:
a main body made of metal, wherein inner sides of the main body come into contact with one or more gases to be stored;
an outer shell formed in at least in some areas of main body;
at least one inlet of the main body and at least one outlet of the main body; and
wherein the outer shell formed in at least some areas of the main body is a multi-layered shell having
a first layer arranged on the main body, wherein the first layer comprises comprising a plurality of sensor elements for detecting state variables, wherein the plurality of sensor elements are arranged at a distance from one another in a fixed position in an elastomer, and
a second layer arranged on an outside of the first layer, wherein this second layer has a matrix and embedded reinforcing elements embedded in the matrix.

2. The pressure vessel for receiving and storing gases as claimed in claim 1, further comprising a permanent electrical contact or a local power source connected permanently or detachably to the pressure vessel.

3. The pressure vessel for receiving and storing gases as claimed in claim 1 wherein the reinforcing elements are tensile cords, and wherein the tensile cords are made of aramid, optionally with an isocyanate stiffener.

4. The pressure vessel for receiving and storing gases as claimed in claim 1 wherein the metal in the main body is steel.

5. The pressure vessel for receiving and storing gases as claimed in claim 1 further comprising an adhesion promoting layer arranged between first layer, containing sensor elements and the metal of the main body.

6. The pressure vessel for receiving and storing gases as claimed in claim 1 further comprising a metal wire or metallized thread configured as a transmitter and/or a receiver in the second layer, wherein the metal wire or metallized thread is optionally part of the reinforcing elements.

7. The pressure vessel for receiving and storing gases as claimed in claim 1 wherein the reinforcement elements comprises an aramid tensile cord in a form of is a fiber bundle of individual filaments made of aramid, wherein the fiber bundle is stiffened with isocyanate, and wherein the fiber bundle has a resozin-formaldehyde-latex cover, and wherein the fiber bundle optionally comprises a metal wire or metallized thread.

8. The pressure vessel for receiving and storing gases as claimed in claim 1 wherein the outer shell essentially encloses or completely encases the main body.

9. A pressure storage system comprising a pressure vessel as claimed in claim 1.

10. The pressure storage system as claimed in claim 9, further comprising a device for generating or transmitting electric fields.

11. The pressure storage system as claimed in claim 9, further comprising a control unit for processing data received from the plurality of sensor elements and for determining relative changes in position of the plurality of sensor elements in relation to one another.

12. The pressure storage system as claimed in claim 9 further comprising an output unit for visualizing the pressure storage system and changes in the state variables determined by the plurality of sensor elements.

13. The pressure storage system as claimed in claim 9, further comprising a device including a control unit for controlling release of gas located in the pressure vessel.

14. The pressure storage system as claimed in claim 9 configured for storing hydrogen.

15. A method of manufacturing a pressure vessel as claimed in claim 1, comprising:
providing a main body;
at least partially encasing of the main body with a first layer, comprising a plurality of sensor elements (5) for detecting state variables, wherein the with this plurality of sensor elements are arranged at a distance from one another in a stationary manner in an elastomer, and wherein the first layer is applied to an outer surface of the main body, optionally with an adhesion promoting layer;
winding tensile cords around the main body having the first layer; and
applying a fixation matrix and an embedding medium on of the tensile cords and curing one or more of the fixation matrix and the embedding medium.

16. The method of manufacturing a pressure vessel as claimed in claim 15, wherein the first layer is obtained by applying the plurality of sensor elements to a film and then applying an elastomer film with subsequent lamination thereof.

17. A device with fuel cells and vessel as claimed in claim 1 for pressure storage of hydrogen.

18. The device as claimed in claim 17, wherein said device is selected from the group consisting of automobiles, commercial vehicles, trains, ships, aircraft, and drones.

19. The pressure vessel for receiving and storing gases of claim 1 further comprising at least one receiver for receiving information and at least one transmitter for sending electrical fields of electromagnetic waves, wherein the at least one receiver and the at least one transmitter are arranged in either or both the first layer and the second layer, and wherein the sensor elements the at least one receiver and the at least one transmitter are in communication with each other.

20. The pressure vessel for receiving and storing gases of claim 1 further comprising a pressure relief valve connected to the main body.
